(19) United States
(12) Patent Application Publication
(10) Pub. No.: US 2026/0274999 A1
(43) Pub. Date: Sep. 17, 2026

(54) NANOCELLULOSE-BASED HYBRID MATERIALS

(71) Applicant: MODERN SYNTHESIS LIMITED, London (GB)

(72) Inventors: Jennifer KEANE, London (GB); Benjamin REEVE, London (GB); loannis ZAMPETAKIS, London (GB); Andreas KAMOLZ, London (GB); Luis UNDRITZ, London (GB); Ivy LI, London (GB); Caitlin BYRNE, London (GB); Owen KENNY, London (GB)

(21) Appl. No.: 19/168,629

(22) PCT Filed: Mar. 28, 2024
(86) PCT No.: PCT/EP2024/058666

§ 371 Date: Sep. 24, 2025

(30) Foreign Application Priority Data
Mar. 28, 2023 (GB) 2304541.2
Aug. 10, 2023 (GB) 2312289.8

(51) Int. Cl. C08B 15/02; C08B 15/00

(52) U.S. Cl. CPC C08B 15/02; C08B 15/005

(57) ABSTRACT

The invention provides a sustainable alternative nanocellulose-based hybrid material having improved strength and flexibility compared to known biopolymers and leather alternatives. The invention further provides methods of producing the nanocellulose-based hybrid material.

### TECHNICAL FIELD

The present disclosure relates to nanocellulose-based hybrid materials and methods of preparing them. The nanocellulose-based hybrid materials may be used in a number of applications including textiles for clothing, footwear, wearable accessories, interior furnishings, automotive and aerospace soft trim, upholstery, packaging and medical use, comprising the materials.

### BACKGROUND

In fashion, sheet/film materials for footwear and accessories usually consist of animal leather, polyurethane or PVC. These materials are durable, thick, flexible and have a soft hand feel but have ethical and sustainability challenges.

Cellulose based non-woven sheets or films are known for producing paper-like materials with applications as filters, absorbent cleaning materials, packaging or disposable products. These materials tend to be too stiff or weak to be used in textile applications.

Bacterial cellulose materials known in the art lack the flex resistance of animal or synthetic leathers, limiting their application.

It is an object of the present invention to provide an alternative, sustainable bio-based material with unique tensile strength and flexibility for use in textile applications.

### SUMMARY OF THE INVENTION

The invention provides a sustainable alternative bio-based material having improved strength and flexibility compared to known biopolymers and leather alternatives.

The invention provides a bio-based material composition comprising (a) cellulose; (b) an anionic polysaccharide; and (c) a cationic polysaccharide; wherein the composition is crosslinked.

In some embodiments the cellulose is nanocellulose. In some embodiments, the cellulose is bacterial nanocellulose.

In some embodiments, the anionic polysaccharide is one or more anionic polysaccharides selected from the group consisting of pectin, alginate, gellan gum, carboxymethylcellulose, hyaluronic acid, and polyglutamic acid (PGA). In some embodiments, the anionic polysaccharide is pectin.

In some embodiments, the cationic polysaccharide comprises or consists of cationic microfibrillated cellulose (MFC) and/or cationic starch.

In some embodiments, the composition is crosslinked by one or more tricarboxylic acids selected from the group consisting of citric acid, isocitric acid, aconitic acid, propane-1,2,3-tricarboxylic acid, agaric acid, and trimesic acid. In some embodiments the composition is crosslinked by chemical and/or by physical crosslinks.

In some embodiments, the composition comprises a humectant. In some embodiments, the composition comprises a humectant, wherein the humectant comprises or consists of one or more humectants selected from the group consisting of glycerol, sorbitol, xylitol, mannitol, erythritol, maltitol, isomalt, lactitol, hydrogenated starch hydrolysates (HSH), and polyglycitol. In some embodiments, the composition comprises glycerol.

In some embodiments, the composition comprises one or more fillers.

In some embodiments, the composition comprises cellulose:anionic polysaccharide:cationic polysaccharide in a ratio of 4:1:5.

The invention further provides a method of producing a bio-based material composition the method comprising the steps of: (a) providing a mixture comprising a cellulose, an anionic polysaccharide, and a cationic polysaccharide; (b) crosslinking the polysaccharides of step (a); and thereby arriving at a bio-based material composition.

In some embodiments, the method of the invention comprises providing a mixture of cellulose, an anionic polysaccharide, and a cationic polysaccharide wherein the ratio by weight of the cellulose:anionic polysaccharide:cationic polysaccharide in step (a) is approximately 4:1:5.

In some embodiments, the method of the invention further comprises a step (i) in which the cellulose is blended, wherein step (i) is carried out prior to step (a). In some embodiments, step (i) comprises blending the cellulose with a humectant and/or water. In some embodiments of the method of the invention the humectant comprises or consists of one or more humectants selected from the group consisting of glycerol, sorbitol, xylitol, mannitol, erythritol, maltitol, isomalt, lactitol, hydrogenated starch hydrolysates (HSH), and polyglycitol. In some embodiments, the humectant comprises glycerol.

In some embodiments of the method of the invention, the method further comprises a step (c) wherein the mixture is heated and/or stirred. In some embodiments of the method of the invention, the method further comprises a step (d) wherein the mixture is cast and/or coated into a mould, onto a scaffold, and/or onto a substrate. In some embodiments of the method of the invention, the method further comprises a step (e) wherein the cast mixture is dried. In some embodiments of the method of the invention, the method further comprises a step (ii), wherein one or more fillers are added to the mixture, wherein step (ii) may be performed before or after step (b). In some embodiments of the method of the invention, the method further comprises a step (iii), wherein one or more dyes are added to the mixture, wherein step (iii) may be performed before step (b), after step (b), after step (c), after step (d), or after step (e). In some embodiments of the method of the invention, the method further comprises a step (iv), wherein the composition undergoes plasma treatment, surface coating, and/or surface functionalisation, wherein step (iv) may be performed after step (b), after step (c), after step (d), or after step (e).

In some embodiments of the invention, the method of producing the composition is a green method in which (a) all reagents and products used in the method are biobased reagents; (b) the method is petrochemical-free; (c) the method only utilises non-toxic chemistries; and/or (d) the method is sustainable.

The invention provides a nanocellulose-based hybrid material comprised of bacterial cellulose (BC), pectin, cationic microfibrillated cellulose (MFC) and glycerol.

In some embodiments, the material comprises cationic MFC, pectin and BC in a ratio of 1:8:11 (Cationic MFC:pectin:BC).

In some embodiments, the material comprises cationic MFC, pectin and BC in a ratio of 1:5:4 (Cationic MFC:pectin:BC).

In some embodiments, the material comprises BC at approximately 15 to 80% by weight, pectin at approximately 10 to 70% by weight, cationic MFC at approximately 1 to 10% by weight, glycerol at approximately 5 to 60% by weight, and/or moisture at approximately 3 to 20% by weight. In some embodiments, the material comprises BC at approximately 0.5 to 50% by weight, pectin at approximately 0.5 to 70% by weight, cationic MFC at approximately 1 to 10% by weight, glycerol at approximately 0.5 to 60% by weight, and/or moisture at approximately 3 to 20% by weight. In one embodiment the material comprises BC at approximately 27.5% by weight, pectin at approximately 20% by weight, cationic MFC at approximately 2.5% by weight, glycerol at approximately 40% by weight, and/or moisture at approximately 10% by weight. In one embodiment, the material comprises BC at approximately 18.2% by weight, pectin at approximately 22% by weight, cationic MFC at approximately 4.5% by weight, glycerol at approximately 40.3% by weight, and/or moisture at approximately 15% by weight.

In an embodiment, the material of the invention is coated on a scaffold. In another embodiment the material of the invention is cast and/or coated onto a scaffold and/or substrate.

In an embodiment, the material further comprises an inorganic filler, such as a ceramic filler (e.g. calcium carbonate).

In some embodiments, the material has a tensile strength of approximately 180N or 18.5 kg. In some embodiments, the material has a maximum elongation of 8.7%. In some embodiments the material has a flex resistance such that it does not crack after 25,000 flexes, when measured by a flexometer, such as a Bally Flexometer and/or according to ISO 5402-1.

The invention further provides the material of the invention for use as a textile. The invention further provides clothing, footwear, wearable accessories, interior furnishings, automotive and aerospace soft trim, upholstery, packaging and medical use, comprising the materials of the present invention.

The invention further provides methods of producing the nanocellulose material of the invention. In one embodiment, the method comprises the steps of (1) obtaining and processing bacterial cellulose; (2) mixing together the bacterial cellulose, pectin, cationic microfibrillated cellulose (MFC), glycerol and, optionally, an inorganic filler to produce a slurry; (3) casting the slurry inside a mould; (4) optionally drying the resulting slurry material; and (5) thereby obtaining the final bio-based material textile of the invention.

In another embodiment, the invention provides a method of producing the nanocellulose material of the invention using a scaffold. The method comprises the steps of (1) obtaining and processing bacterial cellulose; (2) mixing together the bacterial cellulose, pectin, cationic microfibrillated cellulose (MFC), glycerol and, optionally, an inorganic filler to produce a slurry; (3) casting the slurry inside a mould; (4) placing a scaffold inside the slurry; (5) optionally casting further slurry such that the scaffold is encapsulated within the slurry; (6) optionally drying the resulting scaffold-slurry material; and (7) thereby obtaining the final bio-based material textile of the invention.

The mixing step of the method may be performed in an overhead stirrer. The drying step of the method may be performed in an oven.

Within the scope of this disclosure it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

FIG. 1 depicts a scanning electron microscopy (SEM) image of a material according to the present invention. The imaging was performed as described in Example 5. The structure of the nanocellulose-based hybrid material is shown. Fine interlaced fibre networks of the blended biopolymers are visible, with fibres of varying thickness surrounding inclusions of agglomerated biopolymers.

FIGS. 2A to 2H depict the results of stress testing the formulations of Table 5 of Example 7. FIG. 2A relates to formulation B1; FIG. 2B relates to formulation B2; FIG. 2C relates to formulation B3; FIG. 2D relates to formulation B4; FIG. 2E relates to formulation B5 (prepared at pH 4); FIG. 2F relates to formulation B6; FIG. 2G relates to formulation B5 (prepared at pH 10); FIG. 2H relates to formulation B7. The results of the stress testing shown in FIGS. 2A to 2H are shown in Table 5 of Example 7.

FIGS. 3A to 3D depict SEM images of a bio-based material composition according to the present invention, namely a crosslinked nanocellulose-based hybrid material according to formulation B6 of Example 7, produced according to the method of Example 6. The imaging was performed as described in Example 8.

### DETAILED DESCRIPTION

### Definitions

In order to assist with the understanding of the invention several terms are defined herein.

As used herein, the term ‘comprising’ means any of the recited elements are necessarily included and other elements may optionally be included as well. ‘Consisting essentially of’ means any recited elements are necessarily included, elements that would materially affect the basic and novel characteristics of the listed elements are excluded, and other elements may optionally be included. ‘Consisting of’ means that all elements other than those listed are excluded. Embodiments defined by each of these terms are within the scope of this invention.

The terms ‘bacterial cellulose’, ‘nanocellulose’, ‘bacterial nanocellulose’, ‘bacterially produced cellulose’ and ‘bacterially produced nanocellulose’ as used herein may be equivalent and refer to cellulose macromolecules produced by bacteria, such as species from the Komagataeibacter genus (previously known as Gluconacetobacter or Acetobacter) and others, that is characterised by high tensile strength, high tensile stiffness, high chemical purity, biocompatibility and high water-to-cellulose ratio. Suitably, such bacterial nanocellulose will be substantially pure of associated molecules typically present in plant-derived cellulose such as lignin.

As used herein, the term ‘crosslinking’, ‘crosslink’, or ‘crosslinked’, shall be understood to encompass any chemical or physical intermolecular interaction (referred to hereinafter as chemical crosslink(s) and physical crosslink(s)). Non-limiting examples of ‘chemical crosslinks’ are covalent bonds, ionic bonds, and dative bonds. Non-limiting examples of ‘physical crosslinks’ are hydrogen bonding, Van der Waals forces, dipole-dipole interactions, ion-dipole interactions, ion-ion interactions, electrostatic interactions, London dispersion forces, and IT-IT interactions. As used herein, the term ‘chemical crosslink’ may refer to chemical bonds or intermolecular bonds. As used herein, the term ‘physical crosslink’ may refer to electrostatic interactions or steric interactions. As used herein, the term ‘crosslinking’, ‘crosslink’, or ‘crosslinked’, may encompass both chemical and physical crosslinks.

It shall be understood herein that a reference to a material or composition being ‘crosslinked’ (or other declensions thereof) by a ‘crosslinker’, may be understood to mean that the material has undergone a crosslinking reaction facilitated by, involving, consisting of, or comprising the crosslinker, resulting in the formation of crosslinking. Non-limiting examples of such crosslinkers are tricarboxylic acids selected from the group consisting of citric acid, isocitric acid, aconitic acid, propane-1,2,3-tricarboxylic acid, agaric acid, and trimesic acid. The crosslinker may facilitate the crosslinking. The crosslink may consist of or comprise the crosslinker.

As used herein, the terms ‘bio-based material composition’, ‘composition’, ‘bio-based material’, ‘biomaterial’, ‘material’, and ‘nanocellulose-based hybrid material’ are equivalent and interchangeable terms.

As used herein, the term ‘anionic polysaccharide’ may be taken to mean any one or more anionic polysaccharides. An anionic polysaccharide is a polysaccharide possessing a negative electrical charge.

As used herein, the term ‘cationic polysaccharide’ may be taken to mean any one or more cationic polysaccharides. The cationic polysaccharides may comprise naturally cationic and/or cationically modified polysaccharides. A cationic polysaccharide is a polysaccharide possessing a positive electrical charge.

A ‘humectant’ is any substance or compound that possesses hygroscopic properties, enabling it to attract and retain moisture from the surrounding environment. As used herein, the term ‘humectant’ may be taken to mean any one or more humectants. As used herein, a humectant may be a plasticiser.

As used herein, the term ‘strength’ (or declensions thereof) may be taken to mean one or more strength properties tested by the International Organization for Standardization tests ISO 13934-1:2013, BS EN ISO 5402-1:2022, BS EN ISO 4674-1:2016, BS EN ISO 13936-3:2007, BS EN ISO 13935-2:2014, and BS EN ISO 3377-1:2011. ‘Strength’ may also therefore refer to a material's tensile strength. The term ‘tensile strength’ is a term which may be interchangeable with the term ‘Young's Modulus’, ‘Young's Modulus value’, or “YM”. As used herein, the term ‘strength’ may also relate to the longevity of any of the aforementioned properties, i.e. a strong material may have a tensile strength which does not decline significantly over time.

As used herein, the term ‘flexibility’ (or declensions thereof) may be taken to mean flexibility in a dynamic cyclical testing such as Bally Flex testing (e.g. according to ISO 5402-1:2022), or any other suitable equivalent test of flexibility. As used herein, the term ‘flexibility’ may also relate to the longevity of a material's flexible properties, i.e. a flexible material may have a Bally flex which does not decline significantly over time.

As used herein, the term ‘nanocellulose’ is defined as cellulose comprising or consisting of fibres having widths in the nanometre range.

Microfibrillated cellulose (MFC) is cellulose in which the outer layer of the fibres has been stripped away by mechanical shearing, exposing the fibril bundles.

As used herein the terms ‘non-toxic’, or ‘non-toxic chemistries’ may be defined as chemistries, chemicals, or chemical processes substantially allowable by the Control of Substances Hazardous to Health Regulations (COSHH) guidelines. As used herein the terms ‘non-toxic’, or ‘non-toxic chemistries’ may be defined as chemistries, chemicals, or chemical processes which are not considered highly hazardous (for example, to humans, animals, or the environment).

Unless otherwise specified, any composition component ratios defined herein may be interpreted as being inclusive or exclusive of a composition's wet weight. Unless otherwise specified, any composition component ratios defined herein may be interpreted as being calculated as being ratios by weight of the components.

As used herein, the term ‘a’ is used to indicate that a particular element, component, or feature can refer to both the singular and the plural forms. Throughout the description and claims, ‘a’ encompasses instances where there may be a single occurrence as well as multiple occurrences of the element, component, or feature being referred to.

It should be understood that any and all of the various embodiments described herein may be combined within the scope of the present invention.

### Properties of the Nanocellulose-Based Hybrid Material

The invention provides a nanocellulose-based hybrid material with improved strength and flexibility compared to other known leather alternatives.

A material of the present invention has been shown to have a tensile strength of 127 MPa (NB. MPa and N/mm² are equivalent units). Not only does the material of the present invention have a far superior tensile strength when compared to other state of the art leather alternative materials, it also has an improved tensile strength with respect to leather itself.

The material of the present invention achieves a much superior tensile strength to known materials without compromising on flexibility. The material of the present invention has been shown to have a Flex Resistance (as determined using BS EN ISO 5402-1:2022) of no cracks at 25,000 cycles. This level of flexibility renders the material suitable for a wide range of applications envisaged herein. It is surprising that the material retains such a high flexibility despite its high tensile strength. The material further displays this high level of flexibility at an industrially relevant thickness. For example, the Flex Resistance value reported herein was tested at a thickness of 0.8 mm. The material retains a similarly high level of flexibility at other thicknesses, for instance at between around 0.1 and 3.0 mm in thickness.

The material of the present invention has an increased tensile strength compared to leather and/or leather alternatives. In some embodiments, the material has a Young's modulus of at least 50 MPa, at least 75 MPa, at least 100 MPa, at least 125 MPa, at least 150 MPa, or at least 175 MPa. In some embodiments, the material has a Young's modulus of 127 MPa. The Young's modulus value of tensile strength of the material may be measured using ISO 13934-1:2013 or any equivalent or suitable method in the art.

The material of the present invention has a high degree of flexibility and/or flex resistance. In some embodiments, the material has a flex resistance and/or shows no cracking at 15,000 cycles, 20,000 cycles, 25,000 cycles, 30,000 cycles, 35,000 cycles, 40,000 cycles, 45,000 cycles, or 50,000 cycles. In some embodiments, the material has a flex resistance and/or shows no cracking at 25,000 cycles. The flexibility and/or flex resistance of the material may be measured using a flexometer according to BS EN ISO 5402-1:2022 or any equivalent or suitable method in the art.

The material of the present invention has a tear resistance suitable for use in a number of applications envisaged herein. In some embodiments, the material has a tear resistance of at least 3N, at least 5N, at least 6N, at least 7N, at least 8N, at least 9N, or at least 10N. In some embodiments, the material has a tear resistance of at least 5N. The tear resistance of the material may be measured using BS EN ISO 4674-1:2016 or any equivalent or suitable method in the art.

The material of the present invention has a seam slippage resistance suitable for use in a number of applications envisaged herein. In some embodiments, the material has a seam slippage resistance of at least 40N, at least 50N, at least 60N, at least 70N, at least 80N, at least 90N, or at least 100N. In some embodiments, the material has a seam slippage resistance of at least 60N. The seam slippage resistance of the material may be measured using BS EN ISO 13936-3:2007 or any equivalent or suitable method in the art.

The material of the present invention has a seam strength suitable for use in a number of applications envisaged herein. In some embodiments, the material has a seam strength warp of at least 10N, at least 20N, at least 30N, at least 40N, or at least 50N. In some embodiments, the material has a seam strength warp of at least 22N. In some embodiments, the material has a seam strength weft of at least 50N, at least 60N, at least 70N, at least 80N, at least 90, or at least 100N. In some embodiments, the material has a seam strength weft of at least 58N. The seam slippage resistance of the material may be measured using BS EN ISO 13935-2:2014 or any equivalent or suitable method in the art.

The material of the present invention has a tear load suitable for use in a number of applications envisaged herein. In some embodiments, the material has a tear load of at least 2N, at least 3N, at least 4N, at least 5N, at least 6N, at least 7N, at least 8N, at least 9N, or at least 10N. In some embodiments, the material has a tear load of at least 3.7N. The tear load of the material may be measured using BS EN ISO 3377-1:2011 or any equivalent or suitable method in the art.

The material of the present invention overcomes ethical and ecological issues associated with animal-based materials such as leather. The material of the present invention is substantially bio-based, optionally as much as 100% bio-based, sustainable, biodegradable, and suitably petrochemical free. The chemistries employed in the production of the material are of low toxicity, suitably they are non-toxic. Further, unlike other leather-alternative materials (such as ‘fruit leathers’), the material of the present invention has defined starting materials, leading to a more predictable final product, and is therefore suitable for industrial manufacture and quality control.

The strength and flexibility of the material can be attributed to the novel crosslinking in the material, which results in a surprisingly large improvement in the strength and flexibility of the material of the invention. The effect of chemically linking (e.g. through covalent bonding) the cellulose, anionic polysaccharide, and cationic polysaccharide of the material of the invention results in an improvement in the strength of the material beyond what would normally be expected. Furthermore, the use of a cationic polysaccharide (such as cationic MFC) also improves the tensile strength of the material of the invention through promoting ionic crosslinking in the material. Due to the combination of this covalent crosslinking by a covalent crosslinker (such as citric acid), and the ionic interactions between (at least) the anionic and cationic polysaccharides, the material exhibits unexpectedly high strength and flexibility. The effect of combining a cationic polysaccharide and covalent crosslinking is more than additive in improving the properties of strength and flexibility. The material of the invention may be crosslinked covalently and/or ionically. The material of the invention may be crosslinked chemically and/or physically. Further detail of these improved properties of the material of the invention can be found in the Examples, for instance in Example 3, Example 4, Example 7, and/or Example 9.

Using cationic MFC instead of non-cationic MFC results in an unexpectedly high increase in the tensile strength of the material. This can be attributed to strong, chemical cross-linking between the cationic MFC and the crosslinker. Such a high degree of crosslinking is not observed in the presence of non-ionic MFC, which suggests that the high tensile strength of the material of the invention may be attributed to the presence of the cationic group on the cationic MFC (for example, a quaternary amine group). The chemical crosslinking works synergistically with established physical crosslinking between (at least) the cationic MFC and the cellulose via, for example, electrostatic interactions to achieve the high tensile strength of the material of the invention.

### Nanocellulose-Based Hybrid Material

The invention provides a bio-based material composition comprising cellulose, an anionic polysaccharide, and a cationic polysaccharide, wherein the composition is crosslinked. In some embodiments, the cellulose is nanocellulose. In some embodiments, the cellulose is bacterial cellulose. In some embodiments, the cellulose is bacterial nanocellulose. In some embodiments, the anionic polysaccharide is selected from the group consisting of pectin, alginate, gellan gum, carboxymethylcellulose, hyaluronic acid, and polyglutamic acid (PGA). In some embodiments, the anionic polysaccharide is pectin. In some embodiments, the cationic polysaccharide is cationic microfibrillated cellulose (MFC) and/or cationic starch. The cationic polysaccharides may comprise naturally cationic and/or cationically modified polysaccharides. For example, in some embodiments, the cationic polysaccharide comprises a quaternary ammonium cationically modified MFC and/or a quaternary ammonium cationically modified starch. Suitably, polysaccharides employed by the invention may be modified with alternative cationic groups known to those skilled in the art.

The bio-based material composition of the invention may be chemically or physically crosslinked, for example: covalently, ionically, and/or electrostatically crosslinked. The crosslinking of the polysaccharides of the composition results in improved flexibility and strength of the composition. In some embodiments, the composition is crosslinked by one or more tricarboxylic acids selected from the group consisting of citric acid, isocitric acid, aconitic acid, propane-1,2,3-tricarboxylic acid, agaric acid, and trimesic acid. In some embodiments, the composition is crosslinked by citric acid.

A humectant may be incorporated into the material of the invention in order to improve moisture management, prevent static cling, and/or enhance comfort. In some embodiments, the composition comprises a humectant. In some embodiments, the composition of the invention comprises one or more humectants selected from the group consisting of glycerol, sorbitol, xylitol, mannitol, erythritol, maltitol, isomalt, lactitol, hydrogenated starch hydrolysates (HSH), and polyglycitol. In some embodiments, the composition comprises glycerol.

Polymers may be incorporated into the composition in order to achieve further desirable properties for uses envisaged herein. In some embodiments, the composition may comprise polymers selected from the group consisting of polylactic acid (PLA), polyhydroxyalkanoates (PHA), chitosan, polyglycolic acid, polyhydroxyurethanes (PHUs), poly(3-hydroxybutyrate-co-3-hydroxyvalerate)(PHBV), polydioxanone (PDO), poly-ε-caprolactone (PCL), alginate, hyaluronic acid, poly(lactic-co-glycolic acid)(PLGA), carrageenan gum, gum arabic, xyloglucans, and polyethylene glycols (PEG).

Proteins may be incorporated into the composition in order to achieve further desirable properties for uses envisaged herein. In some embodiments, the composition may comprise proteins selected from the group consisting of gelatin, silk, or elastins.

Fillers may be further incorporated into the composition in order to achieve further desirable properties for uses envisaged herein. Ceramic and/or natural short fibre fillers are envisaged for incorporation into the material of the invention. In some embodiments, the composition comprises one or more fillers selected from the group consisting of hydroxyapatite (HA), tricalcium phosphate (TCP), zirconia, alumina, silica, glass ceramics, bioglass, calcium phosphate, calcium, cotton fibres, flax fibres, hemp fibres, jute fibres, bamboo fibres, silk fibres, wool fibres, kenaf fibres, ramie fibres, coconut fibres (coir), banana fibres, bagasse fibres, regenerated cellulose fibres, and wood fibres.

The composition may further comprise surface functionalisation, such as being treated with a sizing agent, being coated with a surface coating, or being plasma treated. In some embodiments, the sizing agents employed in the invention are alkylated ketene dimers, silane chemistries, and acetylation. In some embodiments, the composition may be coated in one or more surface coatings selected from the group consisting of natural waxes, bioplastics, polylactic acid (PLA), polyhydroxyalkanoates (PHA), polyhydroxybutyrate (PHB), cellulose, esters (for example acetate, cellulose acetate butyrate, or other suitable esters), plant protein, soy proteins, pea protein, corn zein, ceramics, liquid nanoglass, and nanoglass. In some embodiments, the composition comprises nanoparticles which absorb and/or emit electromagnetic radiation.

The composition of the invention may further comprise a scaffold and/or substrate. In some embodiments, the scaffold and/or substrate is comprised of one or more materials selected from the group consisting of yarn, textile, electrospun nanofibres, nonwoven fabrics, knitted fabrics, woven fabrics, braided structures, fibre meshes, felts, and porous textiles. In some embodiments, the composition further comprises a backing material, such as a textile. In some embodiments, the composition is adhered to the backing material.

The composition may be used as a bio-based material. The composition may be used as a leather alternative. The composition may be formulated as a sheet. The composition may be embossed and/or stamped. The composition may be less than 10 mm in thickness, less than 5 mm, less than 3 mm, less than 2 mm, or less than 1 mm in thickness. The composition may be greater than 0.01 mm, greater than 0.05, greater than 0.1 mm, or greater than 1 mm in thickness.

Articles comprising the composition are also envisaged. For example, a clothing article, an accessory, a domestic item, an automotive soft trim, automotive upholstery material, or a packaging material, comprising or consisting of the composition of the invention are within the scope of the present invention. Such examples include, but are not limited to: a shoe, a boot, a sandal, a sock, a jacket, a hat, a glove, a shirt, a t-shirt, a jumper, a pair of trousers, underwear, a bag, a handbag, jewellery, sunglasses, glasses, a suitcase, a purse, a wallet, a pencil case, a makeup bag, a mobile phone case, a headphone, a watch strap, a cushion cover, upholstery suitable for a sofa or chair, a curtain, a blind, a lightshade, a carpet, a rug, a doormat, a table mat, a table runner, and a yoga mat.

The use of dyes in the composition is also envisaged to impart technical and/or aesthetic benefits to the composition. In some embodiments, the composition further comprises a dye, or has been dyed. In some embodiments, the dye is a natural dye. In some embodiments, the dye is bacterially produced. In some embodiments, the dye is a colour-changing and/or responsive dye such as an electrochromic, thermochromic, or photochromic dye.

In some embodiments, there is further provided a nanocellulose-based hybrid material comprising bacterial cellulose (BC), heteropolysaccharide, cationic MFC, and humectant. The heteropolysaccharide may be one or more heteropolysaccharides selected from the group consisting of pectin, agar, gelatin, guar gum, and corn-starch. The humectant may be one or more humectants selected from the group consisting of glycerol, polyethylene glycol (PEG), hyaluronic acid, and alpha hydroxy acid such as glycolic acid, lactic acid and citric acid.

In an embodiment, the nanocellulose-based hybrid material of the present invention comprises bacterial cellulose (BC), pectin, cationic MFC, and glycerol.

In some embodiments, the material comprises cationic MFC, pectin and BC in a ratio of 1:8:11 (Cationic MFC:Pectin:BC) by weight.

In some embodiments, the material comprises cationic MFC, pectin and BC in a ratio of 1:5:4 (Cationic MFC:Pectin:BC) by weight.

In an embodiment, the material of the invention is coated on a scaffold. The scaffold may be comprised of one or more materials selected from the group consisting of yarn, textile, electrospun nanofibres, nonwoven fabrics, knitted fabrics, woven fabrics, braided structures, fibre meshes, felts, and porous textiles. In some embodiments, the material is used as a textile or a leather alternative.

In an embodiment, the material further comprises an inorganic filler, such as a ceramic filler (e.g. calcium carbonate). In one embodiment, the material comprises one or more fillers selected from the group consisting of hydroxyapatite (HA), tricalcium phosphate (TCP), zirconia, alumina, silica, glass ceramics, bioglass, calcium phosphate, calcium sulfate, cotton fibres, flax fibres, hemp fibres, jute fibres, bamboo fibres, silk fibres, wool fibres, kenaf fibres, ramie fibres, coconut fibres (coir), banana fibres, bagasse fibres, and wood fibres.

In some embodiments, the material comprises BC at approximately 15 to 80% by weight, pectin at approximately 10 to 70% by weight, cationic MFC at approximately 1 to 10% by weight, glycerol at approximately 5 to 60% by weight, and/or moisture at approximately 3 to 20% by weight. In one embodiment the material comprises BC at approximately 27.5% by weight, pectin at approximately 20% by weight, cationic MFC at approximately 2.5% by weight, glycerol at approximately 40% by weight, and/or moisture at approximately 10% by weight.

In some embodiments, the material comprises BC at approximately 0.5 to 50% by weight, pectin at approximately 0.5 to 70% by weight, cationic MFC at approximately 1 to 10% by weight, glycerol at approximately 0.5 to 60% by weight, and/or moisture at approximately 3 to 20% by weight. In one embodiment, the material comprises BC at approximately 18.2% by weight, pectin at approximately 22% by weight, cationic MFC at approximately 4.5% by weight, glycerol at approximately 40.3% by weight, and/or moisture at approximately 15% by weight.

Bacterial cellulose-derived materials known in the art do not exhibit sufficient flex resistance to be suitable for use as a textile, such as a leather alternative. A key problem addressed by the present invention is improving the flexibility of a bacterial cellulose-derived material, whilst also maintaining strength. As such the material of the invention is hard-wearing, long-lasting, and suitable for the applications envisaged herein.

Adding a heteropolysaccharide such as pectin to the (plasticised) BC improves flexibility but at the expense of tensile strength. However, in some embodiments, the addition of cationic MFC in the preparation of the material of the invention, maintains a level of tensile strength and elongation whilst also keeping flex resistance.

The material of the present invention has a high Bally Flex value (i.e. high flex resistance). The results reported in Example 3 show that the unique formulation of the invention, combined with the production methods of the invention to transform the material from a wet hydrogel to a dried sheet, result in a novel material that not only has comparable tensile strength with commercial textiles but also increased flexibility in a textile testing scenario. The material of the present invention may exhibit no cracking at 25,000 flexes when tested in accordance with EN ISO 17694 (ISO 5402-1:2022 Bally Flex).

The material of the present invention further has high tensile strength suitable for use as a textile and suitable for all applications envisaged herein. The material of the present invention may have a tensile strength of approximately 180N or 18.5 kg, when tested in accordance with ISO 13934-1:2013. Suitably, the material of the present invention may exhibit elongation of approximately 8.7% when tested in accordance with ISO 13934-1:2013.

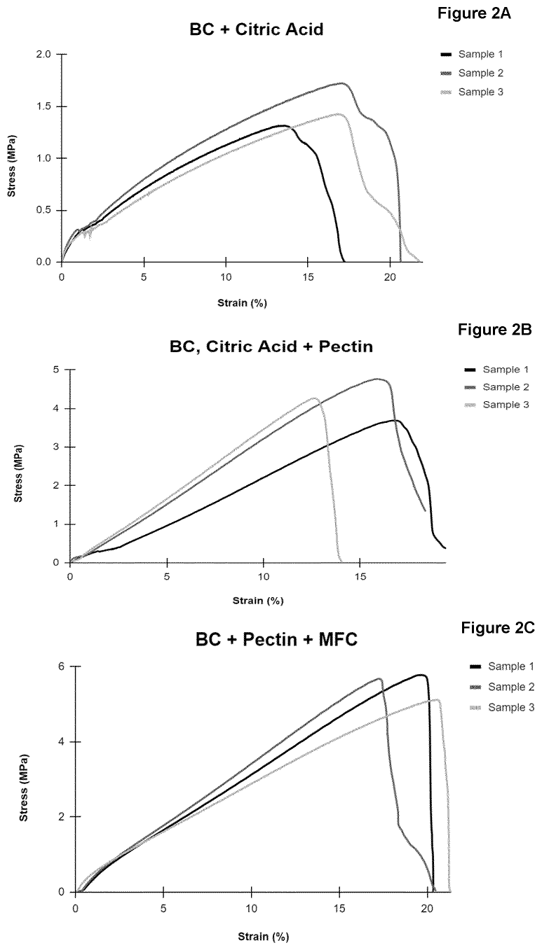

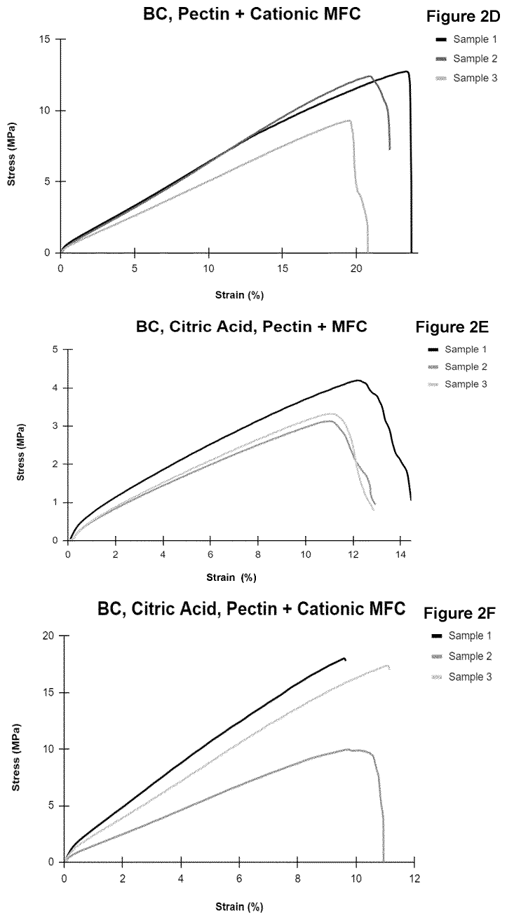

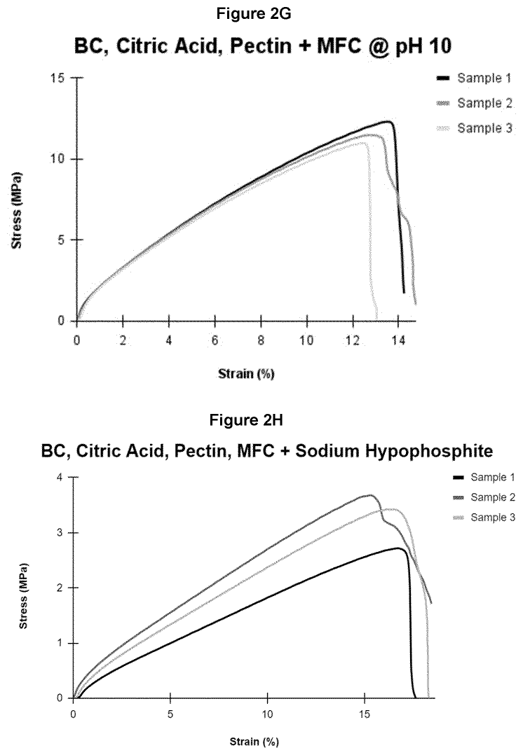

As can be seen from FIG. 2 the nanocellulose-based hybrid material of the present invention has a structure of fine interlaced fibre networks of the blended biopolymers, with fibres of varying thickness surrounding inclusions of agglomerated biopolymers. The nanostructure of the material supports the properties and technical advantages described herein.

It is an advantage of the bio-based material of the present invention that is capable of mimicking, or being an alternative to, a wide spectrum of textiles, from nonwoven films to soft leathers. The material of the invention further possesses at least equivalent or even superior material properties to such textiles.

The material of the invention has improved rheological properties compared to BC and glycerol only slurry formulations.

### Methods of Producing Nanocellulose-Based Hybrid Materials

The invention further provides methods of producing a bio-based material composition. The improved properties of the material of the invention are a result of the crosslinking of the polysaccharides. This is achieved by the use of a crosslinker to produce crosslinking within the composition. The crosslinking imparts surprisingly improved mechanical properties in the form of tensile strength and flexibility.

Furthermore, according to specific embodiments, the method of the invention is a ‘green’ method, meaning that substantially all reagents and products used in the method may be biobased; the method may be petrochemical free; the method may only use low or non-toxic chemistries; and/or the method is sustainable. ‘Reagents’ in this context may be taken to mean anything used in the method. ‘Petrochemical free’ in this context may be taken to mean that no petrochemicals are used as reagents, that no reagents are derived from petrochemicals, and/or petrochemicals are not used in the production of any reagents used in the method. ‘Non-toxic chemistries’ in this context may be taken to mean that no toxic or polluting reagents are used, and/or no toxic or polluting products or byproducts are produced in part of, or as a result of, the method. ‘Sustainable’ in this context may be taken to mean that the method is less energy intensive, less carbon intensive, less water intensive, less land intensive, less resource intensive, results in a longer-lasting product, results in a biodegradable product, and/or produces a lower carbon footprint than traditional methods of making leather, leather alternatives, or other state of the art textiles.

In particular, the material and methods of the invention employ green crosslinkers, such as organic crosslinkers, in contrast to petrochemical-based crosslinkers which are regularly employed in the art.

The invention provides a method of producing a bio-based material composition, comprising the steps of (a) providing a mixture comprising a cellulose, an anionic polysaccharide, and a cationic polysaccharide; (b) crosslinking the polysaccharides of step (a); and thereby producing a bio-based material composition. In some embodiments, the mixture of step (a) further comprises a humectant. In some embodiments, the cellulose is nanocellulose. In some embodiments, the cellulose is bacterial nanocellulose. In some embodiments, the anionic polysaccharide is selected from the group consisting of pectin, alginate, gellan gum, carboxymethylcellulose, hyaluronic acid, and polyglutamic acid (PGA). In some embodiments the anionic polysaccharide is pectin. In some embodiments, the cationic polysaccharide is cationic microfibrillated cellulose (MFC) and/or cationic starch. The cationic polysaccharide may comprise naturally cationic and/or cationically modified polysaccharides. For example, in some embodiments, the cationic polysaccharide comprises a quaternary ammonium cationically modified MFC and/or a quaternary ammonium cationically modified starch. In some embodiments, the ratio by weight of the cellulose:anionic polysaccharide:cationic polysaccharide in step (a) is approximately 4:1:5. In some embodiments, mixture (a) further comprises a humectant. In some embodiments, the ratio by weight of the cellulose:anionic polysaccharide:cationic polysaccharide in step (a) is approximately 2:1:5, 8:1:5, 4:2:5, 4:4:5, 4:1:10, or 4:1:2.5. In some embodiments, mixture (a) further comprises a humectant. Exemplary humectants are provided throughout the application.

In some embodiments, the method of the invention comprises providing a mixture of cellulose, an anionic polysaccharide, and a cationic polysaccharide wherein the ratio by weight of the cellulose:anionic polysaccharide:cationic polysaccharide in step (a) is approximately 2:1:5, 8:1:5, 4:2:5, 4:4:5, 4:1:10, or 4:1:2.5. In some embodiments, the method of the invention comprises providing a mixture of cellulose, an anionic polysaccharide, and a cationic polysaccharide wherein the ratio by weight of the cellulose:anionic polysaccharide:cationic polysaccharide in step (a) is approximately 4:1:5.

In some embodiments, step (b) of the method comprises the addition of a crosslinker. The crosslinking may be chemical or physical crosslinking, for example: covalent, ionic, and/or electrostatic crosslinking. The crosslinking of the polysaccharides of the composition results in improved flexibility and strength of the composition. In some embodiments, the crosslinking is covalent, and the crosslinker is comprised of a tricarboxylic acid. In some embodiments, the crosslinking is covalent and the crosslinker comprises one or more crosslinkers selected from the group consisting of citric acid, isocitric acid, aconitic acid, propane-1,2,3-tricarboxylic acid, agaric acid, and trimesic acid. In some embodiments, the crosslinker is citric acid. In some embodiments, the crosslinker is added to the mixture of step (a) in an amount of around 0.05% w/w, around 0.1% w/w, around 0.2% w/w, around 0.3% w/w, around 0.4% w/w, or around 0.5% w/w.

In some embodiments, the method further comprises a step (i) in which the cellulose is blended, wherein step (i) is carried out prior to step (a). In some embodiments, step (i) comprises blending the cellulose with a humectant and/or water. Blending may include mixing, shearing, combining in an overhead stirrer, or any other suitable method.

In some embodiments, the method further comprises a step (c) wherein the mixture is heated and/or stirred. Step (c) is performed after step (b). In some embodiments, the mixture is heated to a temperature of around 50° C., around 60° C., around 70° C., around 80° C., or around 90° C. In some embodiments, the mixture is stirred at around 250 rpm, around 500 rpm, around 750 rpm, around 1000 rpm, around 1250 rpm, around 1500 rpm, or around 1750 rpm.

In some embodiments, the method further comprises a step (d) wherein the mixture is cast and/or coated into a mould, onto a scaffold and/or onto a substrate. Step (d) is performed after step (b) or after step (c). In some embodiments, the scaffold and/or substrate is comprised of one or more materials selected from the group consisting of yarn, textile, electrospun nanofibres, nonwoven fabrics, knitted fabrics, woven fabrics, braided structures, fibre meshes, felts, and porous textiles.

In some embodiments, the method further comprises a step (e), wherein the cast mixture is dried. Step (e) is performed after step (d).

In some embodiments, the method further comprises step (ii), wherein one or more fillers are added to the mixture, wherein step (ii) may be performed before or after step (b).

In some embodiments, the method further comprises a step (iii) wherein one or more dyes are added to the mixture, wherein step (iii) may be performed before step (b), after step (b), after step (c), after step (d), or after step (e).

In some embodiments, the method further comprises step (iv), wherein the composition undergoes plasma treatment, surface coating, and/or surface functionalisation, wherein step (iv) may be performed after step (b), after step (c), after step (d), or after step (e).

The invention further provides methods of producing the nanocellulose material of the invention. In one embodiment, the method comprises the steps of (1) obtaining and processing bacterial cellulose; (2) mixing together the bacterial cellulose, pectin, cationic microfibrillated cellulose (MFC), glycerol and, optionally, an inorganic filler to produce a slurry; (3) casting the slurry inside a mould; (4) optionally drying the resulting slurry material; and (5) thereby obtaining the final bio-based material textile of the invention.

In another embodiment, the invention provides a method of producing the nanocellulose material of the invention using a scaffold. The method comprises the steps of (1) obtaining and processing bacterial cellulose; (2) mixing together the bacterial cellulose, pectin, cationic microfibrillated cellulose (MFC), glycerol and, optionally, an inorganic filler to produce a slurry; (3) casting the slurry inside a mould; (4) placing a scaffold inside the slurry; (5) optionally casting further slurry such that the scaffold is encapsulated within the slurry; (6) optionally drying the resulting scaffold-slurry material; and (7) thereby obtaining the final bio-based material textile of the invention.

Bacterial cellulose is used as a starting material for the production of the nanocellulose-based hybrid material of the invention. The bacterial cellulose is a fermented biopolymer and may be used as a primary base material in combination with an additional bio-based additive or additives to produce the bio-based material of the invention. The final bio-based material produced is a bio-based textile alternative that achieves defined material testing standards. The bacterial cellulose may suitably meet material testing parameters of thickness, a tensile strength of approximately 180N, and a flex resistance of approximately 25,000 cycles. The bacterial cellulose may be static-grown bacterial nano-cellulose sheets.

The bacterial cellulose is processed as part of the step of obtaining and processing the bacterial cellulose in the method of producing the nanocellulose-based hybrid material of the invention. The bacterial cellulose may be prepared as cubes. The cubes may be any dimension, for example approximately 15×15×15 mm. The bacterial cellulose cubes may be compressed as part of, or prior to, the processing step. The bacterial cellulose cubes may have a dry weight content of approximately 3 to 5% by weight.

The bacterial cellulose may be subjected to a cleaning step as part of, or prior to, the processing step of the method. The cleaning process may comprise one or more disinfection steps and/or washing steps. Disinfection steps may comprise soaking in a bleach solution. Soaking may last at least approximately 12 hours. The bleach solution may comprise approximately 1% by volume of bleach. The ratio of bacterial cellulose to bleach solution may be approximately 1:8 by weight. A wash step may be carried out using any suitable solvent as a wash solution, for example water such as deionised water, distilled water, pure water or tap water. The wash step may comprise soaking in a wash solution. Soaking may last at least approximately 12 hours. The ratio of bacterial cellulose to wash solution may be approximately 1:8 by weight.

In a final processing step, the bacterial cellulose obtained from the cleaning step may be mixed with water to form a mixture to be used in subsequent steps. The bacterial cellulose may be swollen following the wash step. The ratio of bacterial cellulose to water may be 3:8 by weight. Suitably, 3 kg of washed bacterial cellulose is combined with 8 kg of water to form a mixture weighing 11 kg. Optionally the water used in this step may be cold potable water. The dry weight of bacterial nanocellulose following mixing may be approximately 0.5 to 2% by weight.

The methods of producing the nanocellulose material of the invention include a mixing step. In the mixing step processed bacterial cellulose, a humectant (such as glycerol), pectin, and cationic MFC are mixed. An inorganic filler such as a ceramic filler (for example, calcium carbonate) is optionally included in the mixing step. The amount of glycerol added in the mixing step may be calculated based on the weight of water added during the final processing step of the bacterial cellulose processing step. The weight of glycerol added may be 5% by weight of the water added in the final processing step.

The mixing step may be further divided into sub-steps. In a first mixing sub-step, the glycerol and processed bacterial cellulose are mixed using a high-shear mixing process such as blending. The mixture may be processed through high-shear mixing at a constant rate or at a varied rate. The mixture may be subjected to high shear mixing at a constant temperature of between approximately 20 and 30° C. The high shear mixing may last between approximately 1 and 10 minutes. As a result, the first mixing sub-step produces a slurry which is substantially homogenous or completely homogenous mixture.

In a second mixing sub-step, the slurry may be left to rest to allow the humectant (e.g. glycerol) to soak into the bacterial cellulose. This results in the plasticisation of the slurry. The second mixing sub-step may be approximately 12 hours. The second mixing sub-step may optionally include intermittent mixing.

In an optional third mixing sub-step, the slurry is filtered in order to dewater the slurry. Between approximately 50 to 60% of the total slurry weight may be removed by dewatering the slurry. In some embodiments, the filtration is gravity filtration. In some embodiments, the filter is a mesh filter of fixed pore size. The fixed pore size may be approximately 400 microns. In some embodiments, the slurry is segmented into portions before being filtered and is then recombined following dewatering by filtration. The product of the third mixing sub-step is a dewatered slurry.

In a fourth mixing sub-step the cationic MFC is added to the slurry. The weight of cationic MFC added may be calculated as a percentage by weight of the slurry produced in the second or third mixing sub-step. In some embodiments, an amount of cationic MFC equivalent to approximately 4% of the weight of the slurry may be added. The mixture of cationic MFC and slurry may then be stirred. Stirring may be performed in any suitable mixing vessel, such as an overhead stirrer. Stirring in this sub-step may be low shear. A stirring rate of approximately between 50 and 200 rpm, or between 50 and 1000 rpm, may be used. In some embodiments the stirring rate is 100 rpm. In some embodiments the stirring rate is 600 rpm. In some embodiments, stirring may be carried out under vacuum conditions.

In a fifth mixing sub-step the pectin is added to the slurry. The pectin may be added as a powder. The weight of pectin added may be calculated as a percentage by weight of the slurry produced in the second or third mixing sub-step. In some embodiments, an amount of pectin equivalent to approximately 0.7% of the weight of the slurry may be added. The mixture of pectin and slurry may then be stirred in order to avoid aggregation of the pectin. Stirring may be performed in any suitable mixing vessel, such as an overhead stirrer. Stirring in this sub-step may be low shear. A stirring rate of approximately between 50 and 200 rpm may be used. In some embodiments the stirring rate is 100 rpm.

In an optional sixth mixing sub-step the inorganic filler is added to the slurry. The inorganic filler may be added as a powder. The weight of inorganic filler added may be calculated as a percentage by weight of the final mixture following addition of the inorganic filler. In some embodiments, an amount of inorganic filler equivalent to approximately between 0.5% and 10% of the weight of the final slurry may be added. The mixture of inorganic filler and slurry may then be stirred in order to avoid aggregation of the inorganic filler. Stirring may be performed in any suitable mixing vessel, such as an overhead stirrer. Stirring in this sub-step may be low shear. A stirring rate of approximately between 50 and 200 rpm may be used. In some embodiments the stirring rate is 100 rpm.

In a seventh mixing sub-step, the slurry is continuously stirred. Stirring may be performed in any suitable mixing vessel, such as an overhead stirrer. Stirring in this sub-step may be low shear. A stirring rate of approximately between 50 and 200 rpm may be used. In some embodiments the stirring rate is 100 rpm. Stirring in this sub-step may last between 4 and 20 hours. In some embodiments, the stirring in this sub-step may last between 16 and 20 hours.

In some embodiments, the fourth, fifth and sixth mixing sub-steps may be performed in any order. In one embodiment, the mixing sub-steps may be performed in numbered order. In another embodiment the fourth, fifth and sixth mixing sub-steps may be performed simultaneously.

The methods of producing the nanocellulose material of the invention include a step of casting the slurry inside a mould. A layer of the slurry produced in the mixing step may be coated on a solid substrate. The substrate may have dimensions matching the desired size of the final material. In some embodiments the slurry may be extruded into a desired final shape. The slurry may be heated prior to coating using any suitable method, such as a water bath. The slurry may be heated to between approximately 20 to 80° C. The slurry may be coated on the substrate at a thickness of between approximately 0.5 to 20 mm. The slurry may be coated onto the substrate using any suitable tool, such as a scraper or a moveable coater blade, to achieve the coating. In an embodiment, the coating may be uniform in thickness. Alternatively, the coating may vary in thickness between approximately 0.5 and 20 mm. Optionally, the coated substrate may be dried in this step. The substrate may be dried using an oven. The substrate may be dried to remove approximately 90% of the moisture in the coating.

In some embodiments, the methods of producing the nanocellulose material of the invention may include a step of placing a scaffold inside the slurry. The scaffold may be a textile scaffold comprised of woven, non-woven or sheet material comprised of yarns or fibres. The textile scaffold may have a thickness of between approximately 0.1 to 1 mm. The material may comprise one or more materials selected from the group consisting of cotton, regenerated cellulose, linen, hemp, wool, and silk. The textile scaffold may be clamped under tension in a frame larger than the final sheet material and laid on top of the first layer of cast slurry. The tensioning frame may then be clamped to the solid substrate platform. Alternatively, the textile scaffold clamped under tension in a frame may be laid onto the solid substrate platform before the biopolymer layer is coated and the slurry layer is coated on top of it.

In some embodiments the textile scaffold is fed from a roll, with the slurry directly coated onto the textile by knife-over-air coating, knife-over-roller coating, transfer coating, or die coating.

In some embodiments, the methods of producing the nanocellulose material of the invention may include a step of casting further slurry such that the scaffold is encapsulated within the slurry. The material with scaffold and a single side coating of slurry (produced in the previous step of placing a scaffold inside the slurry) may be positioned on a flat substrate platform with the scaffold on a top side. A second layer of slurry is cast over the top of the scaffold material to give a scaffold textile coated on both sides with the biopolymer material. The second layer of slurry may have a similar or identical thickness to the first layer of slurry coated on the solid substrate.

In some embodiments, the methods of producing the nanocellulose material of the invention may optionally include a step of drying the resulting material, which may be a slurry or a scaffold-slurry according to different embodiments. If a scaffold has been employed, the coated scaffold remains under tension during the drying step using a tension means, for example by keeping the scaffold in a frame. The material may be dried for between approximately 60 to 720 minutes, or until the material has lost approximately 90% of its moisture content. The material may be dried at a temperature of between approximately 30 to 80° C. In some embodiments, the material may be dried at a temperature of between approximately 20 to 100° C. During drying, the slurry layer(s) may reduce in thickness by between approximately 5 to 10 times. Depending on the height of the wet slurry layers the final material may have a thickness of between approximately 0.3 to 1.5 mm. If a scaffold has been employed, the tension means may be removed following drying.

Some embodiments of the invention described herein may be defined according to any one of the following numbered clauses:
1. A bio-based material composition comprising:
   (a) cellulose;
   (b) an anionic polysaccharide; and
   (c) a cationic polysaccharide;
   wherein the composition is crosslinked.
2. The composition of clause 1, wherein the cellulose is nanocellulose.
3. The composition of clause 1 or 2, wherein the cellulose is bacterial cellulose.
4. The composition of any of the preceding clauses, wherein the anionic polysaccharide comprises or consists of one or more anionic polysaccharides selected from the group consisting of pectin, alginate, gellan gum, carboxymethylcellulose, hyaluronic acid, and polyglutamic acid (PGA).
5. The composition of any of clauses 1-3, wherein the anionic polysaccharide is pectin.
6. The composition of any of the preceding clauses, wherein the cationic polysaccharide comprises or consists of cationic microfibrillated cellulose (MFC) and/or cationic starch.
7. The composition of any of the preceding clauses, wherein the composition is crosslinked by one or more tricarboxylic acids selected from the group consisting of citric acid, isocitric acid, aconitic acid, propane-1,2,3-tricarboxylic acid, agaric acid, and trimesic acid.
8. The composition of any of the preceding clauses, wherein the composition is crosslinked by chemical crosslinks and/or by physical crosslinks.
9. The composition of clause 8, wherein the chemical crosslinks comprise or consist of covalent and/or ionic bonds.
10. The composition of clause 8 or 9, wherein the physical crosslinks comprise or consist of electrostatic interactions such as hydrogen bonding, Van der Waals forces, dipole-dipole interactions, ion-dipole interactions, ion-ion interactions, electrostatic interactions, London dispersion forces, and/or TT-TT interactions.
11. The composition of any of the preceding clauses, wherein the composition further comprises a humectant.
12. The composition of clause 11, wherein the humectant comprises or consists of one or more humectants selected from the group consisting of glycerol, sorbitol, xylitol, mannitol, erythritol, maltitol, isomalt, lactitol, hydrogenated starch hydrolysates (HSH), and polyglycitol.
13. The composition of any of the preceding clauses, wherein the composition further comprises one or more polymers selected from the group consisting of polylactic acid (PLA), polyhydroxyalkanoates (PHA), chitosan, polyglycolic acid, polyhydroxyurethanes (PHUs), poly(3-hydroxybutyrate-co-3-hydroxyvalerate)(PHBV), polydioxanone (PDO), poly-ε-caprolactone (PCL), alginate, hyaluronic acid, poly(lactic-co-glycolic acid)(PLGA), carrageenan gum, gum arabic, xyloglucans, and polyethylene glycols (PEG).
14. The composition of any of the preceding clauses, wherein the composition further comprises one or more proteins selected from the group consisting of gelatin, silk, or elastins.
15. The composition of any of the preceding clauses, wherein the composition further comprises one or more bio-based elastomers selected from the group consisting of rubber, natural rubber, and epoxidized vegetable oils.
16. The composition of any of the preceding clauses, wherein the composition further comprises one or more fillers.
17. The composition of clause 16, wherein the one or more fillers comprise ceramic fillers selected from the group consisting of hydroxyapatite (HA), tricalcium phosphate (TCP), zirconia, alumina, silica, glass ceramics, bioglass, calcium phosphate, and calcium sulfate.
18. The composition of clause 16 or 17, wherein the one or more fillers comprise natural short fibre fillers selected from the group consisting of cotton fibres, flax fibres, hemp fibres, jute fibres, bamboo fibres, silk fibres, wool fibres, kenaf fibres, ramie fibres, coconut fibres (coir), banana fibres, bagasse fibres, regenerated cellulose fibres, and wood fibres.
19. The composition of any of the preceding clauses for use as a bio-based material.
20 The composition of clause 19, wherein the bio-based material is a leather alternative.
21. The composition of any of the preceding clauses, further comprising surface functionalisation.
22. The composition of clause 21, wherein the surface functionalisation is accomplished by sizing agents, such as alkylated ketene dimers, silane chemistries, and/or acetylation.
23. The composition of any of the preceding clauses, further comprising surface coatings.
24. The composition of clause 23, wherein the surface coatings comprise or consist of one or more selected from the group consisting of natural waxes, bioplastics, polylactic acid (PLA), polyhydroxyalkanoates (PHA), polyhydroxybutyrate (PHB), cellulose, esters (for example acetate, cellulose acetate butyrate, or other suitable esters), plant protein, soy proteins, pea protein, corn zein, ceramics, liquid nanoglass, and nanoglass.
25. The composition of any of the preceding clauses, wherein the surface has been subjected to plasma treatment.
26 The composition of any of the preceding clauses, further comprising a scaffold and/or substrate.
27. The composition of clause 26, wherein the scaffold and/or substrate is comprised of one or more materials selected from the group consisting of yarn, textile, electrospun nanofibres, nonwoven fabrics, knitted fabrics, woven fabrics, braided structures, fibre meshes, felts, and porous textiles.
28. The composition of any of the preceding clauses, further comprising a backing material, such as a textile, optionally wherein the backing material is attached to the composition by adhesion.
29. The composition of any of the preceding clauses, wherein the composition has been dyed using a dye.
30. The composition of clause 29, wherein the dye is a natural dye, optionally wherein the dye is bacterially produced.
31. The composition of clause 29 or 30, wherein the dye is a colour changing and/or responsive dye such as an electrochromic, thermochromic, or photochromic dye.
32. The composition of any of the preceding clauses, further comprising nanoparticles which absorb electromagnetic radiation.
33. The composition of any of the preceding clauses, further comprising nanoparticles which emit electromagnetic radiation.
34. The composition of any of the preceding clauses, wherein the composition has been embossed and/or stamped.
35. The composition of any of the preceding clauses, wherein the composition is a sheet.
36. The composition of any of the preceding clauses, wherein the composition is less than 10 mm in thickness, less than 5 mm, less than 3 mm, less than 2 mm, or less than 1 mm in thickness.
37. The composition of any of the preceding clauses, wherein the composition is greater than 0.01 mm, greater than 0.05, greater than 0.1 mm, or greater than 1 mm in thickness.
38. The composition of any of the preceding clauses, wherein the composition is 0.8 mm in thickness.
39. A clothing article comprising or consisting of the composition of any of clauses 1 to 33.
40 The clothing article of clause 39, wherein the article is selected from the group consisting of a shoe, a boot, a sandal, a sock, a jacket, a hat, a glove, a shirt, a t-shirt, a jumper, a pair of trousers, and underwear.
41. An accessory comprising or consisting of the composition of any of clauses 1 to 38.
42. The accessory of clause 41, wherein the accessory is selected from the group consisting of a bag, a handbag, jewellery, sunglasses, glasses, a suitcase, a purse, a wallet, a pencil case, a makeup bag, a mobile phone case, a headphone, and a watch strap.
43. A domestic item comprising or consisting of the composition of any of clauses 1 to 38.
44. The domestic item of clause 43, wherein the domestic item is selected from the group consisting of a cushion cover, upholstery suitable for a sofa or chair, a curtain, a blind, a lightshade, a carpet, a rug, a doormat, a table mat, a table runner, and a yoga mat.
45. An automotive soft trim or automotive upholstery material comprising or consisting of the composition of any of clauses 1 to 38.
46. A method of producing a bio-based material composition, comprising the steps of:
   (a) providing a mixture comprising a cellulose, an anionic polysaccharide, and a cationic polysaccharide;
   (b) crosslinking the cellulose, anionic polysaccharide, and cationic polysaccharide of step (a);
and thereby producing a bio-based material composition.
47. The method of clause 46, wherein the mixture of step (a) further comprises a humectant.
48. The method of clause 46 or 47, wherein the cellulose is nanocellulose.
49. The method of any of clauses 46 to 48, wherein the cellulose is bacterial cellulose.
50. The method of any of clauses 46 to 49, wherein the anionic polysaccharide is one or more anionic polysaccharides selected from the group consisting of pectin, alginate, gellan gum, carboxymethylcellulose, hyaluronic acid, and polyglutamic acid (PGA).
51. The method of any of clauses 46 to 50, wherein the anionic polysaccharide is pectin.
52. The method of any of clauses 46 to 51, wherein the cationic polysaccharide is cationic microfibrillated cellulose and/or cationic starch.
53. The method of any of clauses 46 to 52, wherein the ratio by weight of the cellulose:anionic polysaccharide:cationic polysaccharide in step (a) is approximately 2:1:5, 8:1:5, 4:2:5, 4:4:5, 4:1:10, or 4:1:2.5.
54. The method of any of clauses 46 to 52, wherein the ratio by weight of the cellulose:anionic polysaccharide:cationic polysaccharide in step (a) is approximately 4:1:5.
55. The method of any of clauses 46 to 54, further comprising a step (i) in which the cellulose is blended, wherein step (i) is carried out prior to step (a).
56. The method of clause 55, wherein step (i) comprises blending the cellulose with a humectant and/or water.
57 The method of any of clauses 46 to 56, wherein the mixture of step (a) further comprises a humectant.
58. The method of clause 56 or 57, wherein the humectant comprises or consists of one or more humectants selected from the group consisting of glycerol, sorbitol, xylitol, mannitol, erythritol, maltitol, isomalt, lactitol, hydrogenated starch hydrolysates (HSH), and polyglycitol.
59 The method of any of clauses 46 to 58, wherein step (b) comprises the addition of a crosslinker.
60. The method of clause 59, wherein the crosslinker is a tricarboxylic acid.
61. The method of clause 60, wherein the crosslinker is one or more tricarboxylic acids selected from the group consisting of citric acid, isocitric acid, aconitic acid, propane-1,2,3-tricarboxylic acid, agaric acid, and trimesic acid.
62. The method of any of clauses 59 to 61, wherein the crosslinker is citric acid.
63. The method of any of clauses 59 to 62, wherein the crosslinker is added to the mixture of step (a) in an amount of around 0.05% w/w, around 0.1% w/w, around 0.2% w/w, around 0.3% w/w, around 0.4% w/w, or around 0.5% w/w.
64. The method of any of clauses 46 to 63, further comprising a step (c) wherein the mixture is heated and/or stirred.
65. The method of clause 64, wherein the mixture is heated to a temperature of around 50° C., around 60° C., around 70° C., around 80° C., or around 90° C.
66. The method of clause 64 or 65, wherein the mixture is stirred at around 250 rpm, around 500 rpm, around 750 rpm, around 1000 rpm, around 1250 rpm, around 1500 rpm, or around 1750 rpm.
67. The method of any of clauses 46 to 66, wherein the method further comprises a step (d) wherein the mixture is cast and/or coated into a mould, onto a scaffold, and/or onto a substrate.
68. The method of clause 67, wherein the scaffold and/or substrate is comprised of one or more materials selected from the group consisting of yarn, textile, electrospun nanofibres, nonwoven fabrics, knitted fabrics, woven fabrics, braided structures, fibre meshes, felts, and porous textiles.
69. The method of clause 67 or 68, wherein the method further comprises a step (e) wherein the cast mixture is dried.
70. The method of any of clauses 46 to 70, wherein the method further comprises a step (ii), wherein one or more fillers are added to the mixture, wherein step (ii) may be performed before or after step (b).
71. The method of clause 70, wherein the one or more fillers comprise ceramic fillers selected from the group consisting of hydroxyapatite (HA), tricalcium phosphate (TCP), zirconia, alumina, silica, glass ceramics, bioglass, calcium phosphate, and calcium sulfate.
72. The composition of clause 70 or 71, wherein the one or more fillers comprise natural short fibre fillers selected from the group consisting of cotton fibres, flax fibres, hemp fibres, jute fibres, bamboo fibres, silk fibres, wool fibres, kenaf fibres, ramie fibres, coconut fibres (coir), banana fibres, bagasse fibres, regenerated cellulose fibres, and wood fibres.
73. The method of any of clauses 46 to 72, wherein the method further comprises a step (iii), wherein one or more dyes are added to the mixture, wherein step (iii) may be performed before step (b), after step (b), after step (c), after step (d), or after step (e).
74. The method of clause 73, wherein the one or more dyes are selected from the group consisting of electrochromic, thermochromic, and photochromic dyes.
75 The method of clause 73 or 74, wherein the dye is bacterially produced.
76 The method of any of clauses 46 to 75, wherein the method further comprises a step (iv), wherein the composition undergoes plasma treatment, surface coating, and/or surface functionalisation, wherein step (iv) may be performed after step (b), after step (c), after step (d), or after step (e).
77. The method of clause 76, wherein the surface functionalisation is accomplished treating the composition with a sizing agent.
78. The method of clause 76 or 77, wherein the composition undergoes surface coating with a surface coating selected from the group consisting of natural waxes, bioplastics, polylactic acid (PLA), polyhydroxyalkanoates (PHA), polyhydroxybutyrate (PHB), cellulose, esters, acetate, cellulose acetate butyrate, plant protein, soy proteins, pea protein, corn zein, ceramics, liquid nanoglass, and nanoglass.
79. The method of any of clauses 46 to 78, wherein the method further comprises a final step of stamping and/or embossing the composition.
80. The method of any of clauses 46 to 79, wherein the method is a green method in which
   (a) all reagents used in the method are biobased reagents;
   (b) the method is petrochemical-free;
   (c) the method only utilises non-toxic chemistries; and/or
   (d) the method is sustainable.
81. The method according to any of clauses 46 to 80, wherein the bio-based material composition is the bio-based material composition of any one of clauses 1 to 45.
82. A nanocellulose-based hybrid material comprising bacterial cellulose (BC), pectin, cationic microfibrillated cellulose (MFC) and glycerol.
83. The nanocellulose-based hybrid material of clause 82, wherein the ratio of cationic MFC:pectin:BC is approximately 1:5:4.
84. The nanocellulose-based hybrid material of clause 82, wherein the ratio of cationic MFC:pectin:BC is approximately 1:8:11.
85. A bio-based material composition comprising:
   (a) bacterial nanocellulose;
   (b) pectin;
   (c) cationic MFC; and
   (d) glycerol;
wherein the composition is crosslinked by citric acid.

### EXAMPLES

The invention described herein is further illustrated by the following examples which in no way should be construed as further limiting.

### Example 1—Production Process for Making Nanocellulose-Based Hybrid Material

### Obtaining and Processing Bacterial Cellulose (BC)

Fermented biopolymer used as a primary base in combination with an additional bio-based additive or additives to produce a bio-based material. The final bio-based material produced is a bio-based textile alternative that achieves defined material testing standards. Material testing parameters met with thickness of 0.5 mm, tensile strength 180N, flex resistance ≥25,000 cycles.

The fermented biopolymer is static-grown bacterial nano-cellulose sheets. The nano-cellulose sheets are prepared as cubes 15×15×15 mm compressed 1:10 with dry weight content of 3-5%.

The said cellulose cubes are treated with a two-step cleaning process prior to processing. The first step is a disinfection step with a 1% bleach solution, this step is a soak and the soaking time is over 12 hours at the fixed 1% bleach solution at a 1:8 ratio of cellulose cube weight to 1% bleach solution. The second and final disinfection step is a wash step with pure water. This step is a soak and the soaking time is over 12 hours at a 1:8 ratio of cellulose cube weight to water.

The cellulose cubes drained from the wash step swell to approximately three times the original weight. The swollen cellulose cubes are weighed and the weight is corrected to 3 Kg using cold potable water. The 3 Kg of swollen cellulose cubes are combined with 8 Kg of cold potable water, forming a mixture of total 11 Kg. Dry weight of nanocellulose in solution is 0.5 to 2% by weight.

### Mixing Together Core Ingredients in an Overhead Stirrer

Glycerol (also referred to as a humectant) is added at this stage to the 8 Kg of water. Glycerol is added based on added water weight in optimal quantities, typically 5%.

The cellulose cube-water-glycerol mixture is processed through high shear (blending). The mixture is processed through high shear (blending) at a constant rate. The high shear processing is done at a constant temperature of between 20 to 30° C. for a fixed time of between 1 to 10 minutes. The high shear (blending) process produces a homogeneous mixture referred to as a slurry from herein. The slurry is left to rest for 12 hours with intermittent mixing. The 12 hours is established as a humectant soak and critical for the plasticising of the cellulose polymer matrix.

The slurry is segmented into portions and optionally subjected to gravity filtration. The gravity filtration is completed using a mesh of fixed pore size, for example the pore size may be approximately 400 microns. The slurry is filtered to remove between 50 to 60% of the weight by removing the water weight. The degree of dewatering is confirmed by weight of the dewatered slurry and the weight of the filtrate.

The addition of Cationic microfibrillated cellulose (MFC) is calculated based on % weight of the original non-dewatered slurry weight. The Cationic microfibrillated cellulose will be known as Cat. MFC from herein. The inclusion rate of the Cat. MFC was at 4% of the original non-dewatered slurry weight. The Cat. MFC is weighed and added to the bulk stock dewatered slurry. The slurry mixture is stirred using an immersed over-head stirrer at a rate of 100 rpm.

The addition of Pectin is calculated based on the % weight of the original non-dewatered slurry weight. The inclusion rate of the pectin was at 0.7% of the original non-dewatered slurry weight. The weighed pectin was slowly incorporated into the stirring slurry mixture avoiding aggregation of pectin powder. Once the pectin was uniformly incorporated into the slurry mixture the bulk mixture was continuously stirred at 100 rpm for 16-20 hours.

Optionally an inorganic filler, for example a ceramic filler such as calcium carbonate may be added at this step as a dry powder. Stirred in to give a weight percentage of 0.5 to 10% in the final product.

Thus a mixed slurry is obtained having approximately 50% by weight dry polymer and 50% by weight of moisture and glycerol.

### Casting of the Mixed Slurry Inside a Mould

A layer of mixed slurry is coated on a solid substrate platform with dimensions matching the size of the final sheet material.

The slurry is heated up in a water bath to a temperature of 20 to 80° C. before the coating. The thickness of the coating can vary between heights of 0.5 mm to 20 mm. To establish the layer different tools can be used—a scraper which evenly disrepute the slurry, the establishment of coating can happen also with the help of a movable coater blade. The height of the coating can be adjusted by the distance between the platform and the coating blade and vary between 0.5-20 mm.

This first layer may optionally be oven dried (using the same method as described in the below drying step) to remove approximately 90% of the moisture before addition of a yarn scaffold.

### Place a Scaffold Inside the Slurry (Optional)

A textile scaffold is incorporated within the material. The scaffold is chosen from a woven, non-woven or knit, sheet material comprised of yarns. The textile has a thickness range of 0.1-1 mm. Preferable materials are natural yarns such as cotton, regenerated cellulose, linen, hemp, wool and silk. The textile is clamped under tension in a frame larger than the final sheet material and laid on top of the first layer of cast slurry. The tensioning frame is the clamped to the solid substrate platform. Alternatively, the textile material clamped under tension in a frame is laid onto the solid substrate platform before the biopolymer layer is coated and the slurry layer is coated on top of it.

The material with scaffold and a single side coating of slurry is positioned on a flat substrate platform with the scaffold on the top side. A second layer of slurry of the same height range as the first is cast over the top of the scaffold material to give a scaffold textile coated on both sides with the biopolymer material.

### Dry the Resulting Material in an Oven

This step is essential if a scaffold is included, but is otherwise optional.

The coated scaffold (if used) remains under tension during drying by keeping it on the frame.

The material is dried for between 60 to 720 minutes at a temp between 30 to 80° C. until the material is dry to the touch and approximately 90% of the moisture has been lost. The slurry layers dry down and reduce in thickness by 5 to 10 times. Depending on the height of the wet slurry layers the final sheet material is then 0.3 to 1.5 mm thick.

If included the tension on the scaffold can then be removed by releasing it from the clamping frame.

### Results

Final product weight compositions produced by the above method, including remaining moisture, are shown below in Table 1.

It is preferred for the bacterial cellulose (BC) to comprise approximately 50% by weight of the final biopolymer (excluding the humectant and moisture). The best formulation has a 1:8:11 ratio of cationic MFC:Pectin:BC.

TABLE 1

| | Best formulation (final | |
|---|---|---|
| | product weight % | Acceptable Range |
| Component | estimate) | (weight % estimate) |
| Bacterial nanocellulose | 27.5% | 15%-80% |
| (BC) | | |
| Pectin | 20% | 10%-70% |
| Cationic MFC | 2.5% | 1%-10% |
| Glycerol | 40% | 5%-60% |
| Moisture | 10% | 3%-20% |

### Example 2-Alternative Formulations of Nanocellulose-Based Hybrid Material

The production method of Example 1 may also be used to produce nanocellulose-based hybrid materials of the invention having a different final formulation to that shown in Table 1. For example, a nanocellulose-based hybrid material was produced according to the method of Example 1, the material having a formulation as set out in Table 2.

Table 2 sets out final product weight composition produced by the method of Example 1, including remaining moisture.

In this example, the best formulation has an approximate 1:5:4 ratio of cationic MFC:Pectin:BC.

TABLE 2

| | Best formulation (final | |
|---|---|---|
| | product weight % | Acceptable Range |
| Component | estimate) | (weight % estimate) |
| Bacterial nanocellulose | 18.2% | 0.5%-50% |
| (BC) | | |
| Pectin | 22% | 10%-70% |
| Cationic MFC | 4.5% | 0.5%-15% |
| Glycerol | 40% | 5%-60% |
| Moisture | 15.3% | 3%-20% |

### Example 3—Properties of Nanocellulose-Based Hybrid Material

Different compositions of nanocellulose-based hybrid material were tested to determine tensile strength, elongation, and Bally flex characteristics. The results are shown in Table 3. Percentage composition as shown in Table 3 excludes moisture. Formulation 3 shows the properties of a material according to the present invention.

The thickness of each composition was measured according to ISO 2286-3:2016. Tensile strength and elongation were measured according to ISO 13934-1:2013. Bally flex was measured according to EN ISO 17694 (ISO 5402-1:2022 Bally flex).

Surprisingly, we found that the material of the present invention has a high Bally flex value. The results show that the unique formulation of the invention, combined with the production methods of the invention, to transform the material from a wet hydrogel to a dried sheet result in a novel material that not only has comparable tensile strength with commercial textiles but also increased flexibility in a textile testing scenario.

Adding a heteropolysaccharide such as pectin to the plasticised BC improves flexibility but at the expense of tensile strength. We found that surprisingly, the addition of cationic MFC maintains a level of tensile strength and elongation whilst also keeping flex resistance.

It can be seen that formulation 3, which is the preferred composition according to the invention, has improved properties compared to other formulations tested. Formulation 1 is known in the art but lacks flex resistance. Blends of BC and a heteropolysaccharide such as pectin have higher flex resistance but low elongation and tensile strength per unit thickness such as formulation 2.

TABLE 3

| | | Thickness | Tensile | Elongation | |
|---|---|---|---|---|---|
| Formulation | Composition | (mm) | Strength (kg) | (%) | Bally Flex |
| 1 | 40% Glycerol | 0.18 | 22.2 | 9.04 | Cracking |
| | 60% BC | | | | at <20,000 flexes |
| 2 | 40% Glycerol | 1.03 | 19.3 | 4.15 | No cracking at |
| | 42% Pectin | | | | 25,000 flexes |
| | 18% BC | | | | |
| 3 | 40% Glycerol | 0.49 | 18.5 | 8.70 | No cracking at |
| | 33% BC | | | | 25,000 flexes |
| | 3% Cationic MFC | | | | |
| | 24% Pectin | | | | |

### Example 4—Properties of Alternative Formulations of Nanocellulose-Based Hybrid Material

The material properties of the alternative formulation of a nanocellulose-based hybrid material as described in Example 2 (produced using the method of Example 1) were tested using the methods as set out in Example 3. The results are shown in Table 4.

The thickness of each composition was measured according to ISO 2286-3:2016. Tensile strength and elongation were measured according to ISO 13934-1:2013. Bally flex was measured according to EN ISO 17694 (ISO 5402-1:2022 Bally flex).

Surprisingly, we found that the material of the present invention has a high Bally flex value. The results show that the formulation of the invention, combined with the production methods of the invention, to transform the material from a wet hydrogel to a dried sheet result in a novel material that not only has comparable tensile strength with commercial textiles but also increased flexibility in a textile testing scenario.

Adding a heteropolysaccharide such as pectin to the plasticised BC improves flexibility but at the expense of tensile strength. We found that surprisingly, the addition of cationic MFC maintains a level of tensile strength and elongation whilst also keeping flex resistance.

It can be seen that formulation 6, which is a preferred composition according to the invention, has improved properties compared to other formulations tested. Formulation 4 is known in the art but lacks flex resistance. Blends of BC and a heteropolysaccharide such as pectin have higher flex resistance but low elongation and tensile strength per unit thickness such as formulation 5.

TABLE 4

| | | Thickness | Tensile | Elongation | |
|---|---|---|---|---|---|
| Formulation | Composition | (mm) | Strength (kg) | (%) | Bally Flex |
| 4 | 40% Glycerol | 0.18 | 22.2 | 9.04 | Cracking |
| | 45% BC | | | | at <20,000 flexes |
| | 15% Moisture | | | | |
| 5 | 40% Glycerol | 1.03 | 19.3 | 4.15 | No cracking at |
| | 27% Pectin | | | | 25,000 flexes |
| | 18% BC | | | | |
| | 15% Moisture | | | | |
| 6 | 40% Glycerol | 0.49 | 18.5 | 8.70 | No cracking at |
| | 18.2% BC | | | | 25,000 flexes |
| | 4.5% Cationic | | | | |
| | MFC | | | | |
| | 22% Pectin | | | | |
| | 15.3% Moisture | | | | |

### Example 5—Structural Microscopy of Nanocellulose-Based Hybrid Material

Scanning electron microscopy was performed on the nanocellulose-based hybrid material to obtain structural information. A sample of the nanocellulose-based hybrid material comprising a 1:8:11 ratio of cationic MFC:Pectin:BC was analysed.

The sample was solvent exchanged into ethanol then critical point dried to remove moisture. The sample was mounted on a metal stub and sputter coated with a layer of silver to reduce charge interruptions then imaged at 8000× magnification.

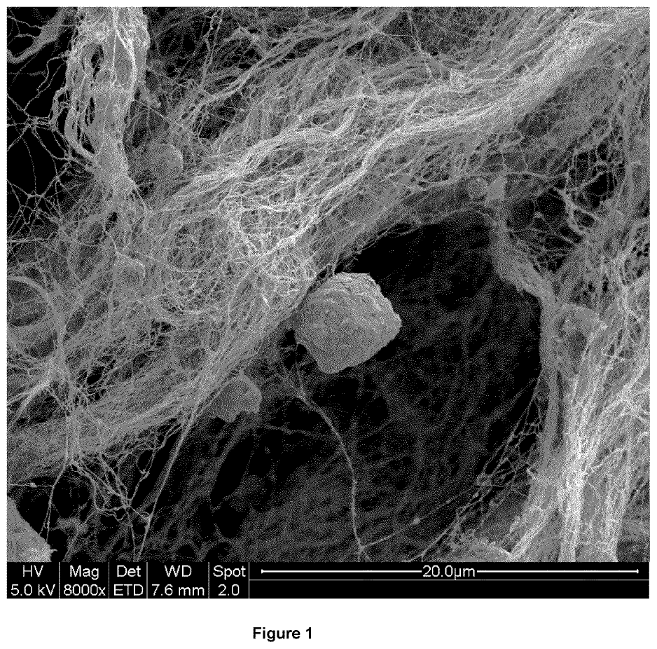

The resulting image can be seen in FIG. 1. FIG. 1 shows the structure of the nanocellulose-based hybrid material. Fine interlaced fibre networks of the blended biopolymers are visible, with fibres of varying thickness surrounding inclusions of agglomerated biopolymers.

### Example 6—Producing a Crosslinked Nanocellulose-Based Hybrid Material

Herein is described a method of producing a crosslinked nanocellulose-based hybrid material according to the present invention containing bacterial cellulose, cat MFC, pectin, glycerol, and citric acid.

Raw materials used in the method: nanocellulose, pectin, cationic microfibrillated cellulose (Cat MFC). Glycerol, citric acid, and water The nanocellulose may be bacterial nanocellulose (BC). The bacterial nanocellulose may be produced as a pristine grown bacterial cellulose sheet with additives introduced. The pectin may be pectin (CAS: 57-50-1), optionally standardised with sucrose (CAS: 9000-69-5). Pectin was obtained from CP Kelco. The Cat MFC may be cellulose 2-hydroxy-3-trimethylammoniumchloridepropylether. Cat MFC was obtained from Weidmann. The glycerol may be vegetable glycerol or vegetable glycerine, and may be pharmaceutical and/or food grade. Glycerol was obtained from Special Ingredients. The glycerol may be used as a plasticiser. The citric acid may be 100% pure, food grade citric acid formulated as fine crystals. The citric acid was obtained from Intralabs. Citric acid is used as a crosslinker.

The production process was as follows:
The nanocellulose was blended in 1 hydrated BC (g): 3 water (mL) containing 5% glycerol, producing a slurry;
The slurry was left to be re-soaked in 1.5 litres of water containing 5% glycerol overnight;
1000 g of the slurry was dewatered using a HEPA filter until 650 g of the slurry remained;
650 g of the dewatered slurry was used to calculate the amount of Cat MFC (65 g), and pectin (5.85 g) to be added;
The dewatered slurry, Cat MFC, and pectin were then mixed for 2 hours to form a slurry mixture;
Citric acid (1.5 g) was added to the slurry mixture;
The resultant mixture was heated to 80° C. using a thermoregulator and stirred at 1000 rpm for 2 hours;
Following this, the mixture was allowed to return to ambient temperature and was stirred overnight;
The slurry was cast into samples each containing 150 g wet weight of the processed slurry in A7 moulds;
The samples were air dried with interfaces in the dehydrator ovens.

### Example 7—Tensile Strength of Alternative Formulations

Tensile strength of various alternative formulations was tested. Tensile strength and elongation were measured according to ISO 13934-1:2013. Table 5 shows the results of tensile strength testing of the various formulations. All formulations were plasticised with glycerol in the same manner as described in Example 6. Formulation B5 was prepared at two different pH values: 4 and 10. The formulations were produced using a method similar to that set out in Example 6. Formulation B6 is a formulation produced by the method set out in Example 6 and as such is an example of a crosslinked nanocellulose-based hybrid material. Young's Modulus is provided in MPa. It is well-known that MPa and N/mm² are equivalent units, with 1 MPa being equal to 1 N/mm².

Tensile tester SOP: Samples are cut into 90 mm×40 mm strips. 20 mm of sample was clamped at either end of the strip giving a 40 mm width and 50 mm length of sample tested. Samples are tested in equilibrium with the standard atmosphere and otherwise according to ISO 13934-1:2013.

Young's Modulus values are independent of the thickness of the sample being measured by ISO 13934-1:2013. Thickness of the tested compositions is provided in Table 5 for reference and completeness only.

TABLE 5

| | | | Young's | |
|---|---|---|---|---|
| | | Thickness | Modulus | |
| Formulation | Composition | (mm) | (MPa) | Conclusion |
| B1 | BC + Citric | 0.31 | 8.3 | Citric acid does not effectively cross |
| | Acid | | | link BC alone. |
| B2 | BC + Pectin + | 0.32 | 30.7 | Modest increase in tensile strength is |
| | Citric Acid | | | likely due to addition of pectin, rather |
| | | | | than crosslinking. |
| B3 | BC + MFC + | 0.93 | 28.9 | Microfibrillated cellulose (MFC) alone |
| | Pectin | | | does not result in increased tensile |
| | | | | strength. |
| B4 | BC + Cat MFC + | 0.42 | 54.7 | Cat MFC causes crosslinking, |
| | Pectin | | | resulting in significantly increased |
| | | | | tensile strength. |
| B5 | BC + MFC + | 0.58 | 34.0 (at | Addition of citric acid causes some |
| | Pectin + | | pH 4) | covalent crosslinking between MFC |
| | Citric Acid | 0.26 | 79.0 (at | and pectin, and MFC and cellulose, |
| | | | pH 10, base | along with a surprising increase in |
| | | | catalysed) | tensile strength. |
| B6 | BC + cat MFC+ | 0.19 | 127 | Use of Cat MFC results in ionic |
| | Pectin + | | | crosslinking, and is also covalently |
| | Citric Acid | | | crosslinked (probably along with the |
| | | | | pectin). This results in a very |
| | | | | surprising large increase in tensile |
| | | | | strength. More than just an additive |
| | | | | effect of the ionic and covalent |
| | | | | crosslinking. |
| B7 | BC + MFC + | 0.31 | 19.4 | Use of catalytic chemicals does not |
| | Pectin + Citric | | | enhance crosslinking. |
| | Acid + Sodium | | | |
| | Hypophosphite | | | |

Tensile stress tests were performed in triplicate on the formulations of Table 5. FIG. 2A to 2H depict the results of stress testing the formulations of Table 5. FIG. 2A relates to formulation B1; FIG. 2B relates to formulation B2; FIG. 2C relates to formulation B3; FIG. 2D relates to formulation B4; FIG. 2E relates to formulation B5 (prepared at pH 4); FIG. 2F relates to formulation B6; FIG. 2G relates to formulation B5 (prepared at pH 10); FIG. 2H relates to formulation B7.

Formulation B1 was made from a BC slurry with the addition of citric acid at 0.5 wt % with a 5% glycerol plasticiser. Addition of citric acid as a crosslinking agent to BC slurry had an overall poor effect on the mechanical strength of the resultant cast composition, exhibiting low Young's Modulus values of approximately 8.3 MPa. This suggests that in this case, citric acid alone cannot effectively act as a crosslinker to this variation of slurry.

Formulation B2 was made from a BC slurry with the addition of citric acid at 0.5 wt % with a 5% glycerol plasticiser and 0.7% pectin bulking agent. In this formulation, the addition of pectin results in an increase in the mechanical strength compared to that of BC slurry alone, however by less than 25 MPa. This suggests that the additional pectin is causing this improvement in quality rather than facilitating the crosslinking of citric acid, and hence infers crosslinking is not yet occurring.

Formulation B3 was made from a BC slurry with the addition of a 5% glycerol plasticiser, microfibrillated cellulose (MFC) and 0.7% pectin bulking agent. This formulation acts as a control for the citric acid crosslinking of slurry containing both MFC and pectin bulking agent without the presence of cationic MFC. The similar value in the Young's Modulus to the formulation B2 confirms the hypothesis that no citric acid crosslinking is occurring in the slurry mixture containing only BC, glycerol and pectin.

Formulation B4 was made from a BC slurry with the addition of a 5% glycerol plasticiser, cationic microfibrillated cellulose (Cat MFC) and 0.7% pectin bulking agent. This formulation also acts as a control for the addition of the cationic form of MFC. In comparison to formulation B3 (the same mixture but with MFC), the substitution for cationic MFC results in a doubling of the overall mechanical strength. The cationic MFC is interacting with the bacterial cellulose component of the mixture; as the BC carries a partial negative charge this interaction is an electrostatic interaction hypothesised to be ionic crosslinking.

Formulation B5 (prepared at pH 4) was made from a BC slurry with the addition of citric acid at 0.5 wt %, a 5% glycerol plasticiser, microfibrillated cellulose (MFC) and 0.7% pectin bulking agent. In this formulation, the addition of citric acid to the BC slurry with MFC (prepared at pH 4) resulted in an approximately 5 MPa increase in mechanical strength relative to formulation B3. This suggests that the nature of the interaction of the citric acid in this instance is not in fact covalently crosslinking, but is rather acting as an additive to increase the mechanical strength.

Formulation B6 was made from a BC slurry with the addition of citric acid at 0.5 wt %, a 5% glycerol plasticiser, cationic microfibrillated cellulose (Cat MFC) and 0.7% pectin bulking agent. In this formulation, the inclusion of the cationic form of MFC resulted in a significant increase in the average Young's Modulus value of over 90 MPa compared to those reported prior. This increase in performance and strength resulting from the inclusion of the cationic form of MFC suggests that a novel interaction, in the form of crosslinking, has taken place between the cationic MFC and citric acid. An electrostatic interaction is hypothesised between the BC and cationic MFC, which explains further the increased performance of the material of this formulation. The exact nature of the crosslinking aspect of this mixture is unknown, but can be attributed to the citric acid and cationic MFC components due to the decreased mechanical strength of formulations containing MFC and those containing no citric acid. It is hypothesised that the positive charge of the quaternary ammonium group present on the MFC accelerates the crosslinking procedure, and hence provides an explanation for the large increase in mechanical strength.

Formulation B5 (prepared at pH 10) was made from a BC slurry with the addition of citric acid at 0.5 wt %, a 5% glycerol plasticiser, microfibrillated cellulose (MFC) and 0.7% pectin bulking agent. In this formulation, changing the conditions of the reaction from pH 4 to basic (pH 10) in order to provide catalysis for the reaction does improve the mechanical strength and properties of the film relative to the same formulation but without base catalysis. However, although there is a significant improvement in the mechanical strength, the increase in performance is not equivalent to that exhibited by formulation B6, where the cationic form of MFC is used in place of the MFC. Although base catalysis certainly improves the degree of citric acid crosslinking, it fails to reach the same level of mechanical strength of the cationic-MFC containing formulation. This further supports the hypothesis that the novel interaction is between the cationic MFC and citric acid, as the performance of the base catalysed equivalent cannot emulate the performance.

Formulation B7 was made from a BC slurry with the addition of citric acid at 0.5 wt %, a 5% glycerol plasticiser, microfibrillated cellulose (MFC), 0.7% pectin bulking agent and sodium hypophosphite at 0.3 wt % for catalytic purposes. This formulation was tested as a control experiment. Inclusion of the catalyst sodium hypophosphite had a detrimental effect on the mechanical strength of the compositions of this formulation. The evidence suggests that catalytic chemicals, such as sodium hypophosphite, do not enhance the crosslinking between MFC and citric acid. This therefore supports the hypothesis that a novel crosslinking mechanism occurs between the citric acid and cationic MFC. The data presented in this Example supports this hypothesis.

Conclusion: Using cationic MFC instead of non-cationic MFC results in an unexpectedly high increase in the tensile strength of the material. The improved tensile strength can be attributed to strong, covalent cross linking between the cationic MFC and the citric acid crosslinker. Such a high degree of crosslinking is not observed in the presence of non-ionic MFC, which suggests that the increase in tensile strength seen in the above experimental data may be attributed to the presence of the quaternary amine group (i.e. the cationic group) on the cationic MFC. The covalent crosslinking works synergistically with established ionic crosslinking between cationic MFC and BC via electrostatic interactions to achieve the high tensile strength of the material of the invention.

### Example 8—Structural Microscopy of Crosslinked Nanocellulose-Based Hybrid Material

Scanning electron microscopy was performed on the nanocellulose-based hybrid material to obtain structural information. A sample of the nanocellulose-based hybrid material produced according to Example 6/formulation B6 of Example 7 was imaged.

The sample was solvent exchanged into ethanol then critical point dried to remove moisture. The sample was mounted on a metal stub and sputter coated with a layer of silver to reduce charge interruptions then imaged at 8000× magnification.

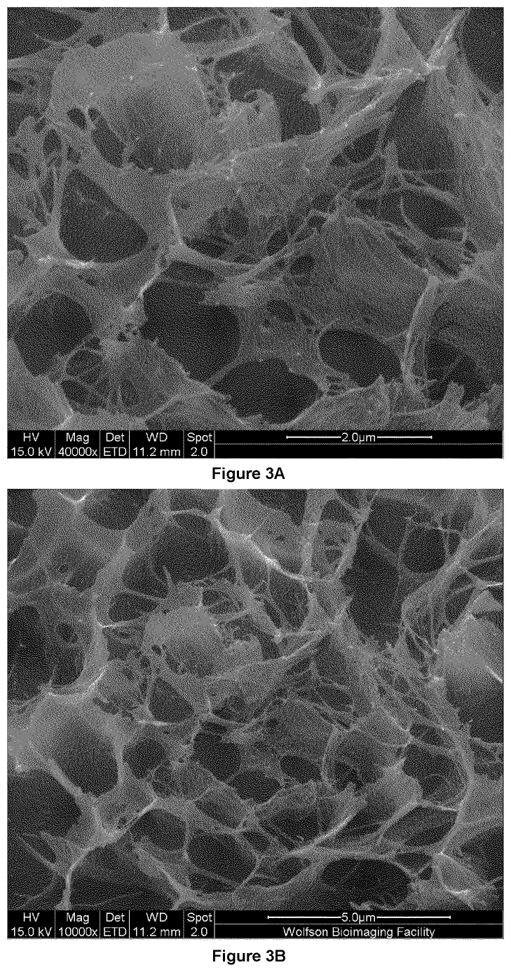

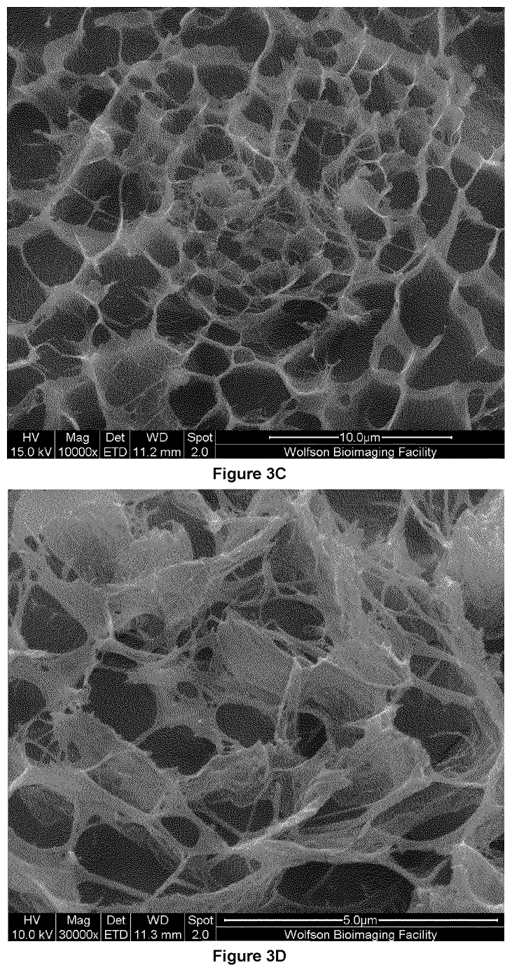

The resulting image can be seen in FIGS. 3A to 3D. FIGS. 3A to 3D show the structure of the nanocellulose-based hybrid material. Fine interlaced fibre networks of the blended biopolymers are visible, with fibres of varying thickness surrounding inclusions of agglomerated biopolymers.

### Example 9—Mechanical Properties of Crosslinked Nanocellulose-Based Hybrid Material

The mechanical properties of a crosslinked nanocellulose-based hybrid material according to the present invention were tested according to several International Organization for Standardization tests, the results of which are displayed in Table 6. The material tested was approximately 0.8 mm.

TABLE 6

| | | Grade/ |
|---|---|---|
| ISO Number | Test | Result |
| BS EN ISO | Leather. Determination of Flex | 25,000 |
| 5402-1: 2022 | Resistance Part 1 - Flexometer Method | cycles |
| BS EN ISO | Tear Resistance of Coated Fabrics and | 5N |
| 4674-1: 2016 | Laminates | |
| BS EN ISO | Seam Slippage Resistance | 60N |
| 13936-3: 2007 | | |
| BS EN ISO | Seam Strength - Grab Method | Warp: 22N |
| 13935-2: 2014 | | Weft: 58N |
| BS EN ISO | Leather tear load, Single edge tear | 3.7N |
| 3377-1: 2011 | | |

The Bally flex of BC+Citric Acid: Cracking at <20,000 cycles. Bally flex was measured according to EN ISO 17694 (ISO 5402-1:2022 Bally flex).

1. A bio-based material composition comprising:
(a) cellulose;
(b) an anionic polysaccharide; and
(c) a cationic polysaccharide;
wherein the composition is crosslinked.

2. The composition of claim 1, wherein the cellulose is nanocellulose, optionally wherein the cellulose is bacterial cellulose.

3. The composition of claim 1, wherein the anionic polysaccharide comprises or consists of one or more anionic polysaccharides selected from the group consisting of pectin, alginate, gellan gum, carboxymethylcellulose, hyaluronic acid, and polyglutamic acid (PGA).

4. The composition of claim 1,
wherein the cationic polysaccharide comprises or consists of cationic microfibrillated cellulose (MFC) and/or cationic starch.

5. The composition of claim 1,
wherein the composition is crosslinked by one or more tricarboxylic acids selected from the group consisting of citric acid, isocitric acid, aconitic acid, propane-1,2,3-tricarboxylic acid, agaric acid, and trimesic acid.

6. The composition of claim 1,
wherein the composition is crosslinked by chemical crosslinks and/or by physical crosslinks.

7. The composition of claim 1,
wherein the composition further comprises a humectant.

8. The composition of claim 1,
wherein the composition further comprises one or more fillers.

9. A method of producing a bio-based material composition, comprising the steps of:
(a) providing a mixture comprising a cellulose, an anionic polysaccharide, and a cationic polysaccharide;
(b) crosslinking the cellulose, anionic polysaccharide, and cationic polysaccharide of step (a);
and thereby producing a bio-based material composition.

10. The method of claim 9, wherein the mixture of step (a) further comprises a humectant.

11. The method of claim 9, wherein the cellulose is nanocellulose.

12. The method of claim 9, wherein the anionic polysaccharide is one or more anionic polysaccharides selected from the group consisting of pectin, alginate, gellan gum, carboxymethylcellulose, hyaluronic acid, and polyglutamic acid (PGA).

13. The method of claim 9, wherein the cationic polysaccharide is cationic microfibrillated cellulose and/or cationic starch.

14. The method of claim 9, wherein the ratio by weight of the cellulose:anionic polysaccharide:cationic polysaccharide in step (a) is approximately 4:1:5.

15. The method of claim 9, further comprising a step (i) in which the cellulose is blended, wherein step (i) is carried out prior to step (a).

16. The method of claim 9, wherein step (b) comprises the addition of a crosslinker.

17. The method of claim 16, wherein the crosslinker is a tricarboxylic acid selected from the group consisting of citric acid, isocitric acid, aconitic acid, propane-1,2,3-tricarboxylic acid, agaric acid, and trimesic acid.

18. The method of claim 9, further comprising a step (c) wherein the mixture is heated and/or stirred.

19. The method of claim 9, wherein the method further comprises a step (d) wherein the mixture is cast and/or coated into a mould, onto a scaffold, and/or onto a substrate.

20. The method of claim 9, wherein the method further comprises a step (ii), wherein one or more fillers are added to the mixture, wherein step (ii) may be performed before or after step (b).

21. The method of claim 9, wherein the method further comprises a step (iii), wherein one or more dyes are added to the mixture, wherein step (iii) may be performed before step (b), after step (b), after step (c), after step (d), or after step (e).

22. The method of claim 9, wherein the method further comprises a step (iv), wherein the composition undergoes plasma treatment, surface coating, and/or surface functionalisation, wherein step (iv) may be performed after step (b), after step (c), after step (d), or after step (e).

23. The method of claim 9, wherein the method is a green method in which
(a) all reagents used in the method are biobased reagents;
(b) the method is petrochemical-free;
(c) the method only utilises non-toxic chemistries; and/or
(d) the method is sustainable.

24. The method according to claim 9, wherein the bio-based material composition is the bio-based material composition of any one of claim 1 to 8.

25. A bio-based material composition comprising:
(a) bacterial nanocellulose;
(b) pectin;
(c) cationic MFC; and
(d) glycerol;
wherein the composition is crosslinked by citric acid.
